(19) United States
(12) Patent Application Publication
(10) Pub. No.: US 2018/0216236 A1
(43) Pub. Date: Aug. 2, 2018

(54) ALUMINUM ALLOY MATERIAL PRODUCTION METHOD, ALUMINUM ALLOY MATERIAL, AND BONDED ARTICLE

(71) Applicant: Kabushiki Kaisha Kobe Seiko Sho (Kobe Steel, Ltd.), Kobe-shi, Hyogo (JP)

(72) Inventors: Satoru TAKADA, Kobe-shi (JP); Yusuke TAKAHASHI, Kobe-shi (JP)

(73) Assignee: Kabushiki Kaisha Kobe Seiko Sho (Kobe Steel, Ltd.), Kobe-shi, Hyogo (JP)

(21) Appl. No.: 15/741,594

(22) PCT Filed: Jun. 28, 2016
(86) PCT No.: PCT/JP2016/069090

§ 371 Date: Jan. 3, 2018

(30) Foreign Application Priority Data
Jul. 9, 2015 (JP) 2015-138049
May 10, 2016 (JP) 2016-094922
Jun. 7, 2016 (JP) 2016-113753

(51) Int. Cl. C23C 22/83; B32B 15/20; B32B 7/12; C23C 22/60

(52) U.S. Cl. CPC C23C 22/83; B32B 15/20; B32B 7/12; B32B 2255/24; B32B 2255/06; B32B 2255/20; C23C 22/60

(57) ABSTRACT

A method for producing an aluminum alloy material includes the steps of a) forming an oxide layer on at least part of an aluminum alloy substrate, and b) forming a surface treatment layer. The oxide layer in the step a) contains Mg in a content from 0.1 atomic percent to less than 30 atomic percent and has a Cu content controlled to less than 0.6 atomic percent. The step b) includes applying an aqueous solution onto at least part of the oxide layer. The aqueous solution has a pH of 7 to 14 and contains a silicate in a concentration of 0.001 mass percent to less than 0.5 mass percent, and an organic silane compound in a concentration of 0.001 mass percent to less than 0.5 mass percent. The method according to the present invention can produce an aluminum alloy material that resists deterioration in bond strength to offer excellent bond durability even when exposed to a hot and humid environment, and has excellent productivity.

### TECHNICAL FIELD

The present invention relates to an aluminum alloy material production method, an aluminum alloy material, and a bonded article inducting the aluminum alloy material.

### BACKGROUND ART

Various aluminum alloy sheet materials are used in members or components of transportation equipment such as automobiles, ships, and aircraft, where the materials are selected as appropriate according to their properties. In addition, demands have been made to reduce weights of such members to provide better fuel efficiency, in consideration of global environmental issues such as CO₂ emission control. Aluminum alloy materials are therefore increasingly used, because of having a specific gravity of about one-third of that of iron and offering excellent energy absorption.

For example, automobile members employ Mg-containing aluminum alloy materials such as JIS 5xxx-series Al—Mg alloys, JIS 6xxx-series Al—Mg—Si alloy sheets, and JIS 7xxx-series Al—Zn—Mg alloys. Exemplary techniques to join or bond these aluminum alloy materials include welding; and bonding with adhesives, where these techniques may be employed in combination. Welding allows the aluminum alloy materials to be bonded at points or along a line. In contrast, bonding with adhesives allows the aluminum alloy materials to be bonded in the entire plane, thereby provides a high bonding strength, and is advantageous in aspects typically of crashworthiness. Accordingly, automobile members employ the bonding with adhesives more and more in recent years. Some automobile members employ a composite of an aluminum alloy material and a resin for weight reduction of automobiles.

However, assume that an automobile member made from an aluminum alloy and bonded with an adhesive undergoes entry of moisture, oxygen, chloride ions, and any other substances into the bonded portion during use. Disadvantageously in this case, the automobile member is gradually degraded at the interface between the adhesive layer and the aluminum alloy sheet to cause interfacial peeling, and thereby has lower bond strength. Under these circumstances, there have been investigated techniques to eliminate or minimize deterioration in bond strength and to allow an automobile member made of an aluminum alloy and having an adhesive layer to have better bond durability (see, for example, Patent Literature (PTL) 1 to 3).

For example, PTL 1 proposes a technique of performing acid wash to remove a Mg-enriched layer from an aluminum alloy sheet surface and, simultaneously, to enrich Cu in the aluminum alloy sheet surface. PTL 2 proposes a technique of allowing the amount of Mg enriched in an aluminum alloy sheet surface and OH absorptivity to be in a specific relation with each other. PTL 3 proposes a technique of successively performing solution treatment and hot-water treatment to control the Mg content, Si content, and OH content in the oxide layer surface layer of an aluminum material within specific ranges.

Independently, PTL 4 proposes aluminum and aluminum alloy materials for automobiles, which materials have been treated with an aqueous solution containing a silicate to form a silicon-containing coating on the surface, so as to eliminate or minimize discoloration and filiform corrosion. In addition, PTL 5 proposes surface treatment technique for a Mg-containing aluminum alloy sheet for automobile bodies. This technique is proposed as a technique of offering uniformity of a zinc phosphate coating while maintaining excellent formability, and employs weak etching. In this literature, surface treatment using a silicate is described as a specific example of the weak etching.

### CITATION LIST

### Patent Literature

PTL 1: Japanese Unexamined Patent Application Publication (JP-A) No. Hei6(1994)-256881

PTL 2: JP-A No. 2006-200007

PTL 3: JP-A No. 2007-217750

PTL 4: JP-A No. Hei8(1996)-144064

PTL 5: JP-A No. Hei7(1995)-188956

### SUMMARY OF INVENTION

### Technical Problem

However, the aluminum alloy materials according to the techniques described in PTL 1 to 3, when exposed to a hot and humid environment from which moisture, oxygen, chloride ions, and any other substances enter the materials, undergoes more and more degradation at the interface, and this causes, for example, interfacial peeling and deterioration in bond strength, and promotes aluminum corrosion. For example, PTL 1 mentions that the copper enrichment strengthens bonding with the adhesive to provide better adhesiveness. However, an aluminum alloy sheet to which the technique is applied may undergo more and more decomposition of the resin in a humid environment and is not expected to have high bond durability.

The techniques described in PTL 4 and PTL 5 also employ surface treatment using a silicate. The techniques, however, employ the surface treatment using a silicate alone. In addition, the techniques relate to painting but does not relate to bond durability. Accordingly, although the techniques may provide corrosion resistance, which is important for painting, but lack consideration on strength, which is necessary for bond durability, and are not expected to effectively provide better bond durability.

Accordingly, the present invention has a main object to provide a method for producing an aluminum alloy material, an aluminum alloy material, and a bonded article obtained using the aluminum alloy material, where the method can produce an aluminum alloy material which resists deterioration in bond strength and offers excellent bond durability even when exposed to a hot and humid environment, and which can be produced with excellent productivity.

### Solution to Problem

After intensive investigations to achieve the objects, the inventors of the present invention found as follows. In an aluminum alloy material obtained by the technique of performing acid wash, the aluminum alloy sheet base metal and the adhesive layer are bonded through hydrogen bonds. This causes the aluminum alloy material, when exposed to a hot and humid, degradative environment, to have lower bonding strength (weaker hydrogen bonds) due to hydration at the interface.

Independently, there is a technique of performing anodization to form an oxide layer. Also in an aluminum alloy sheet material obtained by this technique, the aluminum alloy sheet base metal and the adhesive layer are bonded through hydrogen bonds. The aluminum alloy material, when exposed to a hot and humid environment from which moisture, oxygen, chloride ions, and any other substances penetrate, deteriorates in bonding strength due to hydration at the interface. In addition, the technique of performing anodization requires a complicated apparatus and high facility cost, requires a long time to form the oxide layer, and suffers from low production efficiency. Also in an aluminum alloy material obtained by the technique of performing hot-water treatment, the aluminum alloy sheet base metal and the adhesive layer are bonded together through hydrogen bonds. This aluminum alloy material, when exposed to a hot and humid environment, undergoes hydration at the interface, and this enhances degradation at the interface, causes interfacial peeling, and causes deterioration in bond strength.

On the basis of these findings, the inventors made investigations on bonding state between the substrate surface and the adhesive resin layer and found that deterioration in bond strength upon exposure to a hot and humid environment can be restrained by forming an oxide layer on the aluminum alloy substrate, and applying a specific aqueous solution containing a silicate and an organic silane compound to at least part of the oxide layer to form a surface treatment layer. The present invention has been made on the basis of these findings.

Specifically, a method according to the present invention for producing an aluminum alloy material includes an oxide layer forming step and a surface treatment layer forming step. The oxide layer forming step is the step of forming an oxide layer on at least part of an aluminum alloy substrate. The oxide layer contains Mg in a content from 0.1 atomic percent to less than 30 atomic percent and has a Cu content controlled to less than 0.6 atomic percent. The surface treatment layer forming step includes applying an aqueous solution onto at least part of the oxide layer. The aqueous solution contains a silicate in a concentration of 0.001 mass percent to less than 0.5 mass percent, and an organic silane compound in a concentration of 0.001 mass percent to less than 0.5 mass percent and has a pH of 7 to 14.

The Mg content and the Cu content in the oxide layer are values as measured by glow discharge-optical emission spectroscopy (GD-OES).

In the method according to the present invention for producing an aluminum alloy material, the organic silane compound may include at least one of a silane compound containing hydrolyzable trialkoxysilyl groups in a molecule, a hydrolyzed product of the silane compound, and a polymer derived from the silane compound.

In the method according to the present invention for producing an aluminum alloy material, the silicate may be a silicate represented by mM₂O.nSiO₂, where M is a monovalent cation; m is the number of moles of M₂O; and n is the number of moles of SiO₂, and the ratio n/m of n tom may be 1.5 or more.

In the method according to the present invention for producing an aluminum alloy material, the monovalent cation M may be a sodium ion.

In the method according to the present invention for producing an aluminum alloy material, the oxide layer forming step may include an etching substep, and etching in the etching substep may be performed to an amount of 1.9 g/m² or less.

The aluminum alloy substrate may be made typically of an aluminum alloy selected from the group consisting of Al—Mg alloys, Al—Cu—Mg alloys, Al—Mg—Si alloys, and Al—Zn—Mg alloys.

The present invention also includes an aluminum alloy material obtained by the method for producing an aluminum alloy material.

A bonded article according to the present invention includes the aluminum alloy material, another member, and an adhesive resin through which the aluminum alloy material and the other member bond with each other.

### Advantageous Effects of Invention

The present invention can actually provide an aluminum alloy material that resists deterioration in bond strength and offers excellent bond durability even when exposed to a hot and humid environment. In addition, the present invention enables production of such an aluminum alloy material (also referred to as a “surface-treated aluminum alloy material”) through a simplified process, by performing silicate treatment and organic silane treatment simultaneously on an aluminum alloy substrate bearing an oxide layer, using an aqueous solution containing a silicate and an organic silane compound. This can reduce capital investment and production cost.

### BRIEF DESCRIPTION OF DRAWINGS

FIG. 1 is a flow chart illustrating a method according to a first embodiment of the present invention for producing an aluminum alloy material;

FIG. 2 is a schematic cross-sectional view of an aluminum alloy material before the surface treatment step and illustrates a configuration of the aluminum alloy material, where the aluminum alloy material includes an aluminum alloy substrate, and an oxide layer disposed on the aluminum alloy substrate;

FIG. 3 is a schematic cross-sectional view of an aluminum alloy material bearing an adhesive resin layer according to the first embodiment of the present invention and illustrates a configuration thereof.

FIG. 4 is a schematic cross-sectional view of an aluminum alloy material bearing an adhesive resin layer according to a modification of the first embodiment of the present invention and illustrates a configuration thereof.

FIG. 5 is a flow chart illustrating a method for producing the aluminum alloy material illustrated in FIG. 4, which material bears an adhesive resin layer;

FIG. 6 is a schematic cross sectional view of a bonded article according to a second embodiment of the present invention and illustrates an exemplary configuration thereof.

FIG. 7A is a schematic cross-sectional view of the bonded article according to the second embodiment of the present invention and illustrates another exemplary configuration thereof.

FIG. 7B is a schematic cross-sectional view of the bonded article according to the second embodiment of the present invention and illustrates yet another exemplary configuration thereof.

FIG. 8 is a schematic cross-sectional view of the bonded article according to the second embodiment of the present invention and illustrates still another exemplary configuration thereof.

FIG. 9A is a schematic cross-sectional view of the bonded article according to the second embodiment of the present invention and illustrates another exemplary configuration thereof.

FIG. 9B is a schematic cross-sectional view of the bonded article according to the second embodiment of the present invention and illustrates another exemplary configuration thereof.

FIG. 10A is a side view of a bonded test sample and illustrates how to measure a cohesive failure rate;

FIG. 10B is a plan view of the bonded test sample and illustrates how to measure the cohesive failure rate.

### DESCRIPTION OF EMBODIMENTS

One or more embodiments of the present invention will be illustrated in detail below. It should be noted, however, that the embodiments described below are never intended to limit the scope of the present invention.

### First Embodiment

Initially, the method for producing an aluminum alloy material, and an aluminum alloy material obtained by the production method, each of which are according to this embodiment, will be described. In this description, a percentage based on mass (mass percent) is the same as a percentage based on weight (weight percent).

The method according to the embodiment for producing an aluminum alloy material includes an oxide layer forming step and a surface treatment layer forming step. The oxide layer forming step forms an oxide layer on at least part of an aluminum alloy substrate, where the oxide layer contains Mg in a content from 0.1 atomic percent to less than 30 atomic percent and has a Cu content controlled to less than 0.6 atomic percent. The surface treatment layer forming step includes applying an aqueous solution onto at least part of the oxide layer, where the aqueous solution contains a silicate in a concentration of 0.001 mass percent to less than 0.5 mass percent, and an organic silane compound in a concentration of 0.001 mass percent to less than 0.5 mass percent. The aqueous solution has a pH of 7 to 14.

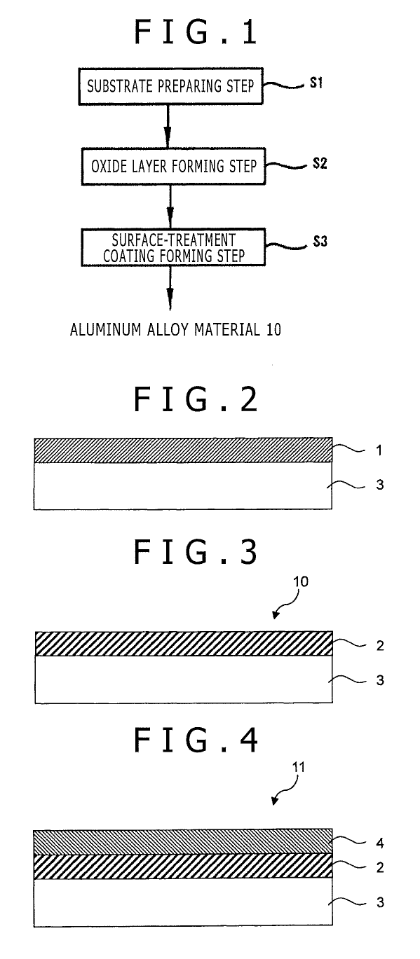

FIG. 1 is a flow chart illustrating the method for producing an aluminum alloy material 10 according to the embodiment. As illustrated in FIG. 1, to produce the aluminum alloy material 10 according to the embodiment, the method performs a substrate preparing step S1, an oxide layer forming step S2, and a surface treatment layer forming step S3. The steps will be described one by one below.

Step S1: Substrate Preparing Step

The substrate is not limited in its shape and may have any shape, according typically to the shape of a member to be produced using the aluminum alloy material. Non-limiting examples of the shape of the substrate include not only a sheet shape, but also any other shapes which products such as cast materials, forged materials, and extruded materials (for example, hollow rods) can have. For example, a sheet-form substrate (base plate or base sheet) is prepared in the substrate preparing step S1 typically by the following procedure. Initially, an aluminum alloy having a predetermined chemical composition is melted and cast by continuous casting to give an ingot (melting-casting step). Next, the prepared ingot is subjected to homogenization (soaking) (homogenization step). The homogenized ingot is then hot-rolled to give a hot-rolled sheet (hot rolling step). The hot-rolled sheet is subjected to a heat treatment as rough annealing or process annealing at 300° C. to 580° C., subjected to cold rolling at least once, to a final cold rolling reduction of 5% or more, and yields a cold-rolled sheet (base sheet) having a predetermined thickness (cold rolling step).

In the cold rolling step, the heat treatment as rough annealing or process annealing is preferably performed at a temperature of 300° C. or higher, and this allows the resulting substrate to offer better formability more effectively. The rough annealing or process annealing is preferably performed at a temperature of 580° C. or lower. This allows the substrate to more readily resist deterioration in formability, which will be caused by occurrence of burning. The final cold rolling reduction is preferably set to 5% or more. This contributes to better formability more effectively. The homogenization and hot rolling may be performed under any conditions not limited, and can be performed under such general conditions for the production of hot-rolled sheets. The process annealing does not always have to be performed.

Substrate

The substrate (aluminum alloy substrate) includes (is made of) an aluminum alloy. The aluminum alloy to constitute the substrate is not limited in its type and may be selected as appropriate according to the intended use of the member into which the aluminum alloy material is processed, and may be selected from various non-heat-treatment or heat-treatment type aluminum alloys prescribed in, or according approximately to, Japanese Industrial Standards (JIS). Non-limiting examples of the non-heat-treatment type aluminum alloys include pure aluminum (1xxx-series), Al—Mn alloys (3xxx-series), Al—Si alloys (4xxx-series), and Al—Mg alloys (5xxx-series). Non-limiting examples of the heat-treatment type aluminum alloys include Al—Cu—Mg alloys (2xxx-series), Al—Mg—Si alloys (6xxx-series), and Al—Zn—Mg alloys (7xxx-series).

For example, assume that the aluminum alloy material according to the embodiment of the present invention is used to form an automobile member. In this case, the substrate preferably has a 0.2% yield strength of 100 MPa or more, from the viewpoint of strength. Non-limiting examples of aluminum alloys that can form substrates satisfactorily having the property (sufficient strength) include those containing a relatively large amount of magnesium, such as 2xxx-series, 5xxx-series, 6xxx-series, and 7xxx-series aluminum alloys. These alloys may be subjected to heat treatment (temper) as needed. Of such various aluminum alloys, 6xxx-series aluminum alloys are preferably employed, because these aluminum alloys have excellent age hardenability, require relatively smaller amounts of alloy elements, give scrap capable of recycling with good recyclability, and have excellent formability.

Step S2: Oxide Layer Forming Step

The oxide layer forming step (step S2) forms an oxide layer on at least part (namely, part or entire) of the surface of the substrate prepared from the substrate preparing step S1, where the oxide layer contains Mg in a content from 0.1 atomic percent to less than 30 atomic percent and has a Cu content controlled to less than 0.6 atomic percent. Specifically, the oxide layer forming step (step S2) in the present embodiment includes, for example, a heat treatment substep and an etching substep. The heat treatment substep thermally treats a substrate 3 to form an oxide layer 1. The etching substep is performed after the heat treatment substep.

FIG. 2 illustrates the aluminum alloy material before the surface treatment layer forming step, where the aluminum alloy material includes the substrate 3, and the oxide layer 1 disposed on the substrate 3. In the aluminum alloy material before the surface treatment layer forming step illustrated in FIG. 2, the oxide layer 1 is disposed entirely on one side of the substrate 3, but the present embodiment is not limited to this configuration. For example, the oxide layer 1 may be disposed on only part of the surface of the substrate 3. The oxide layer 1 may also be disposed on both sides of the substrate 3.

The heat treatment in the heat treatment substep may be performed by heating the substrate 3 up to a temperature typically of 400° C. to 580° C. to form the oxide layer 1 on the substrate 3. In addition, the heat treatment has the effect of adjusting the strength of the aluminum alloy material 10. The heat treatment performed herein is solution treatment when the substrate 3 is made of a heat-treatment type aluminum alloy; and is heat treatment in annealing (final annealing) when the substrate 3 is made of a non-heat-treatment type aluminum alloy.

This heat treatment is preferably performed as rapid heating at a heating rate of 100° C./min or more, from the viewpoint of offering higher strength. The rapid heating, when performed up to a heating temperature of 400° C. or higher, contributes to higher strength of the aluminum alloy material 10 as intact and after post-painting heating (baking). In contrast, the rapid heating, when performed up to a heating temperature of 580° C. or lower, can restrain deterioration in formability, which will be caused by occurrence of burning. In addition, from the viewpoint of offering higher strength, the substrate is preferably held for a holding time of 3 to 30 seconds in the heat treatment. Thus, the heating of the substrate 3 at a heating temperature of 400° C. to 580° C. forms the oxide layer 1 on the substrate 3, where the oxide layer 1 has a thickness of typically 1 to 30 nm. Another treatment such as alkaline degreasing may be performed before the heat treatment.

The etching substep after the heat treatment performs at least one of treatment with an acidic solution (acid wash) and treatment with an alkaline solution (alkali wash, alkaline degreasing) partially or entirely on the substrate 3. An agent liquid for use in the acid wash (acid wash agent) may be selected typically from, but not limited to, solutions containing at least one selected from the group consisting of sulfuric acid, nitric acid, and hydrofluoric acid. The acid wash agent may contain a surfactant to obtain higher degreasing ability. Conditions for the acid wash can be set as appropriate in consideration typically of the alloy chemical composition of the substrate 3 and the thickness of the oxide layer 1, and are not limited. For example, the acid wash may be performed at a pH of 4 or lower (preferably a pH of 2 or lower) and a treatment temperature of 10° C. to 80° C. for a treatment time of 1 to 120 seconds.

An agent liquid for use in the alkali wash (alkaline degreasing) is also not limited, but may be selected typically from solutions containing at least one selected from the group consisting of sodium hydroxide and potassium hydroxide. Conditions for the treatment with the alkaline solution can be set as appropriate in consideration typically of the alloy chemical composition of the substrate 3 and the thickness of the oxide layer 1, and are not limited. For example, the alkali wash may be performed at a pH of 10 or greater and a treatment temperature of 10° C. to 80° C. for a treatment time of 1 to 120 seconds.

When the alkali wash is to be performed, the acid wash is preferably performed before the alkali wash. Alternatively, the acid wash alone may be performed without alkali wash. Specifically, a final substep in the etching substep is preferably acid wash. The reasons for this are as follows. Specifically, it is difficult to remove Mg from the substrate surface by alkali wash, and the presence of Mg in the substrate surface requires a larger amount of etching. However, such a larger amount of etching causes copper enrichment. To eliminate or minimize this, Mg should be removed from the substrate surface by acid wash.

Rinsing is preferably performed after washing with any of the agent liquids. Examples of the rinsing procedure include, but are not limited to, spraying and immersion. Non-limiting examples of a cleaning liquid for use in rinsing include industrial water, pure water, and ion-exchanged water.

By the etching substep performed in the above manner, the Mg content is adjusted to from 0.1 atomic percent to less than 30 atomic percent, and the Cu content is controlled to less than 0.6 atomic percent in the oxide layer 1. The Mg content and the Cu content in the oxide layer can be adjusted or controlled by appropriately controlling conditions in the acid wash and the alkali wash, where the conditions are exemplified typically by treatment time, treatment temperature, and concentration and pH of the agent liquid.

The amount of etching in the etching substep is preferably 1.9 g/m² or less. The etching, if performed to an amount of greater than 1.9 g/m², may cause copper enrichment in the surface of the substrate 3 and may cause degradation of the adhesive resin in a hot and humid, degradative environment. The etching amount is more preferably 1.5 g/m² or less, and furthermore preferably 1.3 g/m² or less. The lower limit of the etching amount is preferably, but not limitingly, 0.005 g/m².

The etching amount (in g/m²) in the description refers to a value determined by measuring a weight reduction (in gram) of the substrate between before and after the oxide layer forming step, and dividing the weight reduction by the surface area (in square meter).

Oxide Layer 1

With the oxide layer forming step, the oxide layer 1 is formed on at least part of the substrate 3, where the oxide layer 1 contains Mg in a content from 0.1 atomic percent to less than 30 atomic percent, and has a Cu content controlled to less than 0.6 atomic percent. Preferred ranges of contents of elements contained in the oxide layer 1 will be described below.

Mg Content

The aluminum alloy constituting the substrate of the aluminum alloy material generally contains magnesium as an alloy element. When the oxide layer 1, which is a complex oxide of aluminum and magnesium, is formed on the surface of the substrate 3, a magnesium oxide layer is present as enriched in the surface. The work as intact in this state has such an excessively thick magnesium oxide layer and thereby causes the after-mentioned surface treatment layer (surface treatment coating) 2 to contain a large amount of magnesium, even when the work undergoes the subsequent surface treatment layer forming step S3. The resulting surface treatment layer 2 formed in this manner fails to have sufficient strength as the coating layer itself and has low initial adhesiveness.

In addition, the Mg-enriched oxide layer also causes hydration at the interface with the adhesive resin layer and corrosion of the substrate in a hot and humid environment, from which moisture, oxygen, chloride ions, and any other substances may enter the material. This causes the aluminum alloy material to have lower bond durability. Specifically, the oxide layer 1 before the formation of the surface treatment layer, if containing Mg in a content of 30 atomic percent or more, tends to cause the aluminum alloy material after the formation of the surface treatment layer to have lower adhesiveness and/or lower bond durability. To eliminate or minimize this, the Mg content in the oxide layer 1 is controlled to less than 30 atomic percent in the method for producing the aluminum alloy material 10 according to the embodiment. This allows the aluminum alloy material to have better initial adhesiveness and better bond durability. The Mg content in the oxide layer 1 before the formation of the surface treatment layer is preferably less than 25 atomic percent, more preferably less than 20 atomic percent, and furthermore preferably less than 10 atomic percent. The range is preferred from the viewpoint of offering better initial adhesiveness and better bond durability.

In contrast, the lower limit of the Mg content in the oxide layer 1 before the formation of the surface treatment layer is controlled to 0.1 atomic percent or more in the method for producing the aluminum alloy material 10 according to the embodiment, from the viewpoint of economic efficiency. The Mg content in the oxide layer 1 before the formation of the surface treatment layer herein can be measured by glow discharge-optical emission spectroscopy (GD-OES).

Cu Content

If excessive etching is performed on the substrate 3 by a degreasing substep or acid wash substep in the formation of the oxide layer 1, Cu contained in the substrate 3 is enriched in the surface to increase the Cu content in the oxide layer 1. The presence of excessive Cu in the surface of the oxide layer 1 causes the surface treatment layer 2 to contain excessive Cu, and this causes the aluminum alloy material to have lower bond durability, where the surface treatment layer 2 is formed in the subsequent surface treatment layer forming step S3.

To eliminate or minimize this, the Cu content in the oxide layer 1 before the formation of the surface treatment layer is controlled to less than 0.6 atomic percent in the method for producing the aluminum alloy material 10 according to the embodiment. The Cu content in the oxide layer 1 before the formation of the surface treatment layer is more preferably less than 0.5 atomic percent.

Film Thickness

The oxide layer 1 before the formation of the surface treatment layer preferably has a thickness of 1 to 30 nm. Assume that the oxide layer 1 before the formation of the surface treatment layer has a thickness less than 1 nm. In this case, the surface treatment solution for use in the surface treatment layer forming step becomes excessive, because the oxide layer 1 with which the surface treatment solution reacts is thin. Thus, the unreacted surface treatment solution remains on the substrate, and this may cause deterioration in bond durability. Even if the surface treatment solution is not excessive, the control of the thickness of the oxide layer 1 before the formation of the surface treatment layer to less than 1 nm requires excessive treatment such as excessive acid wash, thereby causes lower productivity and tends to give lower practicality. In addition, excessive etching by alkaline degreasing or acid wash causes Cu contained in the substrate 3 to be enriched in the surface and causes deterioration in bond durability. To eliminate or minimize this, the etching amount is preferably controlled to 1.9 g/m² or less.

In contrast, assume that the oxide layer 1 before the formation of the surface treatment layer has a thickness greater than 30 nm. In this case, the surface treatment solution used in the surface treatment layer forming step is insufficient with respect to the oxide layer 1 and reacts insufficiently with the oxide layer 1, and this may cause deterioration in bond durability. In addition, such oxide layer 1 having a thickness greater than 30 nm contains a large amount of magnesium, thereby the oxide layer itself may have lower strength and have lower initial adhesiveness. More preferably, the oxide layer 1 before the formation of the surface treatment layer has a thickness from 2 nm to less than 20 nm. This is preferred from the viewpoints typically of performance in chemical conversion treatment, and productivity.

Step S3: Surface-Treatment Layer Forming Step

The surface treatment layer forming step (step S3) includes applying an aqueous solution (surface treatment solution) onto at least part of the oxide layer 1 formed in the step S2, where the aqueous solution has a pH of 7 to 14 and contains a silicate in a concentration of 0.001 mass percent to less than 0.5 mass percent, and an organic silane compound in a concentration of 0.001 mass percent to less than 0.5 mass percent. The surface treatment by applying the surface treatment solution to the oxide layer 1 formed in the oxide layer forming step (step S2) causes the oxide layer 1 and the surface treatment solution to react with each other to form a surface treatment layer 2 on the substrate 3, where the surface treatment layer includes aluminum (Al), silicon (Si), oxygen (O), and the organic silane compound. However, this does not mean that the oxide layer 1 becomes a homogeneous surface treatment layer 2. The oxide layer 1 is modified into a film or layer mainly containing Al and O and further containing Si (namely, including Al—O—Si bonds); and, on the modified layer, a coating layer mainly containing Si and O (siloxane bonds) and further containing Al (namely, including Al—O—Si bonds) is formed. The resulting coating layer has a structure in which the Si content decreases, and the Al content increases, from the outermost surface toward the substrate side. Specifically, the ratio between Al and Si in the Al—O—Si bonds varies in the cross-sectional direction (thickness direction). The surface treatment layer 2 and the substrate 3 are bonded to each other through Al-rich Al—O—Si bonds. This allows the coating layer to have a strength with the aluminum alloy substrate at an equivalent level as compared with the strength of the oxide layer 1. In addition, the surface-treated material (aluminum alloy material after the surface treatment), as having Si-rich Al—O—Si bonds in its surface, can offer better corrosion resistance. It is also possible to form chemical bonds between the organic silane compound and the adhesive resin, and this provides still better corrosion resistance and strengthens bonding between the coating layer and the adhesive resin. The surface treatment layer 2 itself is very thin and structurally includes the silicate and the organic silane compound in combination as a mixture, although their distributions are different in the thickness direction. The surface treatment layer 2 itself therefore has high strength as being extremely thin. As described above, the surface treatment with the surface treatment solution containing both the silicate and the organic silane compound forms the surface treatment layer 2, and gives an alloy material having better bond durability as compared with the case where surface treatment with the organic silane compound alone is performed.

FIG. 3 illustrates the aluminum alloy material according to the present invention, where the aluminum alloy material includes the substrate 3, and the surface treatment layer 2 disposed (formed) on the substrate 3. In the aluminum alloy material illustrated in FIG. 3, the surface treatment layer 2 is disposed entirely on one side of the substrate 3, but the present embodiment is not limited to this configuration. For example, the surface treatment layer 2 may be disposed partially on the substrate 3. Alternatively, the surface treatment layer 2 may be disposed on both sides of the substrate 3.

The surface treatment solution for use to form the surface treatment layer will be described below.

The surface treatment solution has a pH of 7 to 14. The surface treatment solution, if having a pH greater than 14, becomes an unstable solution by itself, because most of the organic silane compound is polymerized and precipitates. The resulting polymer of the organic silane compound, if bonded to the oxide layer disposed on the aluminum alloy substrate, forms an organic silane treatment layer having a large thickness, and this organic silane treatment layer may undergo fracture inside thereof upon application of stress. In contrast, the surface treatment solution, if having a pH less than 7, may cause the silicate to precipitate, and this may impede the reaction between aluminum and silicon. To eliminate or minimize these, the pH of the surface treatment solution should be controlled within the range of 7 to 14. The surface treatment solution has a pH of preferably 8 or greater, and more preferably 9 or greater. The pH of the surface treatment solution can be adjusted as appropriate typically by adding a base or an acid to the solution, where the base is exemplified typically by sodium hydroxide, sodium carbonate, and ammonia, and the acid is exemplified typically by acetic acid.

The surface treatment solution contains the silicate in a concentration of 0.001 mass percent to less than 0.5 mass percent. The surface treatment solution, if containing the silicate in a concentration of 0.5 mass percent or more, may form an excessively thick coating, resulting in lower strength. In contrast, the surface treatment solution, if containing the silicate in a concentration less than 0.001 mass percent, may fail to allow aluminum and silicon to react with each other sufficiently due to an excessively low silicate concentration and may fail to allow the aluminum alloy material to have sufficient bond durability. The silicate concentration in the surface treatment solution is preferably 0.01 mass percent or more, and more preferably 0.015 mass percent or more; and is preferably less than 0.3 mass percent, and more preferably less than 0.2 mass percent.

The surface treatment solution contains the organic silane compound in a concentration of 0.001 mass percent to less than 0.5 mass percent. The surface treatment solution, if containing the organic silane compound in a concentration of 0.5 mass percent or more, may form an excessively thick surface treatment layer, resulting in lower strength. In contrast, the surface treatment solution, if containing the organic silane compound in a concentration less than 0.001 mass percent, may fail to sufficiently form a surface treatment layer containing the organic silane compound due to the excessively low content of the organic silane compound, and this may cause insufficient bond durability. The organic silane compound concentration in the surface treatment solution is preferably 0.005 mass percent or more, and more preferably 0.01 mass percent or more; and is preferably less than 0.4 mass percent, and more preferably less than 0.3 mass percent.

The silicate contained in the surface treatment solution for use in the present invention is not limited in its type. However, preferred examples of the silicate from the viewpoint of water solubility include basic silicates such as silicates containing a monovalent cation (M), including silicates of alkali metals such as lithium, sodium, and potassium; and ammonium silicate. These silicates are represented by the formula: mM₂O.nSiO₂, where m represents the number of moles of M₂O; and n represents the number of moles of SiO₂. These silicates may be hereinafter indicated by the ratio n/m of n tom. The monovalent cation M is preferably selected from alkali metal ions such as lithium ion, sodium ion, and potassium ion, of which sodium ion is particularly preferred from the viewpoint of economic efficiency.

Non-limiting examples of the silicates represented by mM₂O.nSiO₂ include crystalline sodium orthosilicate (mNa₂O.nSiO₂ where n/m is about 0.5), sodium metasilicate (mNa₂O.nSiO₂ where n/m is about 1), crystalline layered sodium silicate (mNa₂O.nSiO₂ where n/m is from about 1.5 to about 3), noncrystalline sodium silicate, and water glass (Nos. 1, 2, and 3 prescribed in JIS standards; mNa₂O.nSiO₂ where n/m is from about 1.5 to about 4), which is liquid.

Among them, preferred are silicates having a ratio n/m of 1.5 or more. These are preferred for providing good bond durability. The surface treatment solution, if containing a silicate having a ratio n/m less than 1.5, tends to form a coating layer having somewhat lower corrosion resistance, and this may cause the resulting article to offer lower bond durability, where the coating layer is formed by the reaction between the aluminum oxide layer and the aqueous solution containing the silicate and the organic silane compound. The ratio n/m is not limited in its upper limit, but is preferably 4 or less in view of silicate production. Specifically, examples of such preferred silicates include crystalline layered sodium silicates and water glass. In particular, crystalline layered silicates have high ion exchange capacity, form small amounts of reaction products with minerals, less deposit on the apparatus and container, and are particularly preferred from the viewpoint of stabilization of operation.

The surface treatment solution may contain each of different silicates alone or in combination.

The organic silane compound contained in the surface treatment solution for use in the present invention is not limited in its type, but may include at least one of a silane compound containing hydrolyzable trialkoxysilyl groups in a molecule, a hydrolyzed product of the silane compound, and a polymer derived from the silane compound. The silane compound containing hydrolyzable trialkoxysilyl groups in a molecule not only forms dense siloxane bonds by self-polymerization, but also has high reactivity with a metal oxide to form a chemically stable coating layer, and allows the resulting coating to have still better humid durability. In addition, the organic silane treatment layer has high solubility (compatibility) mutually with organic compounds such as working oils; press forming oils and other machine oils; and adhesives. The coating layer, even when working oils, press forming oils, and other machine oils are deposited thereon, can mitigate the influence of the oils and plays a role of eliminating or minimizing deterioration in bond durability caused by such oil application. The silane compound is not limited in its type, but preferably selected from silane compounds containing two hydrolyzable trialkoxysilyl groups in a molecule (bissilane compounds), from the viewpoint of economic efficiency. Non-limiting examples of such bissilane compounds for use herein include bis(trialkoxysilyl)ethanes, bis(trialkoxysilyl)benzenes, bis(trialkoxysilyl)hexanes, bis(trialkoxysilylpropyl)amines, and bis(trialkoxysilylpropyl) tetrasuffides. In particular, bis(triethoxysilyl)ethane (BTSE) is preferred from the viewpoints of versatility and economic efficiency. The surface treatment solution may contain each of different organic silane compounds alone or in combination.

The organic silane compound may include at least one of a silane coupling agent containing a reactive functional group capable of chemically bonding with an organic resin component; a hydrolyzed product of the silane coupling agent and a polymer derived from the silane coupling agent. For example, the use of a silane coupling agent containing a reactive functional group alone or in combination with the silane compound enables formation of chemical bonds between the coating and the resin to offer still better bond durability, where non-limiting examples of the reactive functional group include amino group, epoxy group, methacrylic group, vinyl group, and mercapto group. The functional group of the silane coupling agent is not limited to those listed above, and a silane coupling agent containing any of various functional groups can be selected and used as appropriate according to the adhesive resin to be used. Preferred, but non-limiting examples of the silane coupling agent include 3-aminopropyltrimethoxysilane, 3-aminopropyltriethoxysilane, 3-(N-aminoethyl)-aminopropyltrimethoxysilane, 3-(N-aminoethyl)-aminopropyltriethoxysilane, 3-mercaptopropyltrimethoxysilane, 3-mercaptopropyltriethoxysilane, 3-glycidoxypropyltrimethoxysilane, 3-glycidoxypropyltriethoxysilane, 3-methacryloxypropyltrimethoxysilane, and 3-methacryloxypropyltriethoxysilane. The surface treatment solution may contain each of different silane coupling agents alone or in combination.

When desired, the surface treatment solution may further include one or more other components, such as stabilizers and auxiliaries, than the silicates and the organic silane compounds. For example, the surface treatment solution may contain, as the stabilizer, an organic compound which is exemplified typically by C₁-C₄ carboxylic acids such as formic acid and acetic acid; and C₁-C₄ alcohols such as methanol and ethanol.

Non-limiting examples of the technique to apply the surface treatment solution include immersion treatment, spraying, roll coating, bar coating, and electrostatic coating. Rinsing is preferably not performed after the surface treatment, but may be performed typically with pure water.

The surface treatment solution after application is dried by heating as needed. The heating may be performed at a temperature of preferably 70° C. or higher, more preferably 80° C. or higher, and furthermore preferably 90° C. or higher. In contrast, the heating may be performed at a temperature of preferably 220° C. or lower, more preferably 200° C. or lower, and furthermore preferably 190° C. or lower, because heating at an excessively high temperature may adversely affect the properties of the aluminum alloy. The drying (heating) may be performed for a time of preferably 2 seconds or longer, more preferably 5 seconds or longer, and furthermore preferably 10 seconds or longer, while the drying time may vary depending on the heating temperature. The drying may be performed for a time of preferably 20 minutes or shorter, more preferably 5 minutes or shorter, and furthermore preferably 2 minutes or shorter.

For sufficiently effectively providing better bond durability, the mass of coating of the surface treatment solution is preferably adjusted so that the coating after drying is present in an amount of 0.001 mg/m² to 30 mg/m²; and is more preferably adjusted so that the coating after drying is present in an amount of 0.01 mg/m² to 20 mg/m². The surface treatment solution, if applied in an excessively small mass of coating, may fail to offer good bond durability, because of an excessively small amount of the silicate or the organic silane compound. In contrast, the surface treatment solution, if applied in an excessively large mass of coating, may form an excessively thick surface treatment layer, and this may cause peeling or separation in the surface treatment layer and impair bond durability. In addition, assume that such excessively thick surface treatment layer is subjected typically to a degreasing-etching step for painting after an automobile assembly step. In this case, the surface treatment layer is hardly removed by the step, may thereby adversely affect paint adhesion and/or may cause difference (unevenness) in paint adhesion.

Other Steps

The method according to the embodiment for producing the aluminum alloy material 10 may further include one or more other steps during, before, and/or after the above-mentioned steps, within ranges not adversely affecting the steps. For example, the method may include a pre-aging step of subjecting the work to pre-aging, after the surface treatment layer forming step S3. The pre-aging is preferably performed via low-temperature heating at 40° C. to 120° C. for 8 to 36 hours, as started within 72 hours after the step S3.

Pre-aging, when performed under this condition, can contribute to better formability and higher strength after baking. In addition or alternatively, the method may further include any of other steps such as the step of removing foreign substances from the surface of the aluminum alloy material 10, and the step of removing defective pieces formed in the steps.

The produced aluminum alloy material 10 is coated with a machine oil such as a press forming oil before the preparation of the bonded article, or before processing into an automobile member. The press forming oil for use herein is mainly selected from ones containing an ester component. The technique and conditions to coat the aluminum alloy material 10 with a press forming oil are not limited, and may be selected from a wide variety of techniques and conditions for general coating with a press forming oil. For example, the coating may be performed by immersing the aluminum alloy material 10 in a press forming oil containing ethyl oleate as the ester component. The ester component for use herein is not limited to ethyl oleate, but may also be selected from various ester components such as butyl stearate and sorbitan monostearate.

The aluminum alloy material 10 according to the embodiment includes, as the outermost surface, the surface treatment layer 2 having good compatibility with a machine oil. Thus, even after the machine oil is applied onto the aluminum alloy material, the adhesive resin can be satisfactorily bonded thereunto.

As is described in detail above, the method according to the embodiment for producing the aluminum alloy material 10 enables production of aluminum alloy materials through a simplified process and can reduce capital investment and production cost, by simultaneously performing silicate treatment and organic silane treatment on an aluminum alloy substrate bearing an oxide layer, using an aqueous solution containing a silicate and an organic silane compound. The aluminum alloy material 10 according to the embodiment has a Mg content in the oxide layer 1 before the surface treatment layer forming step controlled within the specific range, can restrain elusion of the substrate 3, restrain fragility caused by magnesium oxide in the surface of the substrate 3 to thereby restrain degradation of the adhesive resin, where the fragility will be caused with the elution. In addition, the aluminum alloy material 10 has a Cu content in the oxide layer 1 before the surface treatment layer forming step controlled less than the specific level, and this contributes to better bond durability between the adhesive resin and the surface treatment layer 2, which is formed by the surface treatment on the oxide layer 1. As a result, the aluminum alloy material 10 according to the embodiment resists interfacial peeling even when exposed to a hot and humid environment and can restrain deterioration in bond strength over a long duration. The aluminum alloy material can offer better bond durability as compared with one prepared by surface treatment using an organic silane compound alone.

Modification of First Embodiment

Next, an aluminum alloy material bearing an adhesive resin layer according to a modification of the first embodiment of the present invention will be described. FIG. 4 is a schematic cross-sectional view of an aluminum alloy material bearing an adhesive resin layer according to the present modification and illustrates a configuration thereof. In FIG. 4, a component (constituent) identical to that in the aluminum alloy material 10 illustrated in FIG. 3 is indicated with the identical reference sign, and detailed description of which is omitted herein. As illustrated in FIG. 4, the aluminum alloy material 11 bearing an adhesive resin layer according to the modification includes an adhesive resin layer 4 made from an adhesive resin, where the adhesive resin layer 4 is disposed so as to cover the surface treatment layer 2 in the aluminum alloy material according to the first embodiment.

Adhesive Resin Layer 4

The adhesive resin layer 4 is made typically from an adhesive resin. The aluminum alloy material 11 bearing an adhesive resin layer according to the modification is bonded to another member through the adhesive resin layer 4.

The category of the “other member” includes other aluminum alloy materials bearing a surface treatment layer as with the aluminum alloy material 11 bearing an adhesive resin layer; aluminum alloy materials bearing neither oxide layer nor surface treatment layer; and resin molded articles.

The adhesive resin to constitute the adhesive resin layer 4 is not limited and may be selected from adhesive resins conventionally used for bonding of aluminum alloy materials, such as epoxy resins, urethane resins, nitrile resins, nylon resins, and acrylic resins.

The adhesive resin layer 4 has a thickness of preferably, but non-limitingly, 10 to 500 μm, and more preferably 50 to 400 μm. The adhesive resin layer 4, if having a thickness less than 10 μm, may fail to offer high bond durability when the aluminum alloy material 11 bearing an adhesive resin layer is bonded, through the adhesive resin layer 4, to another aluminum alloy material not bearing an adhesive resin layer. In contrast, the adhesive resin layer 4, if having a thickness greater than 500 μm, may offer lower bond strength.

Production Method

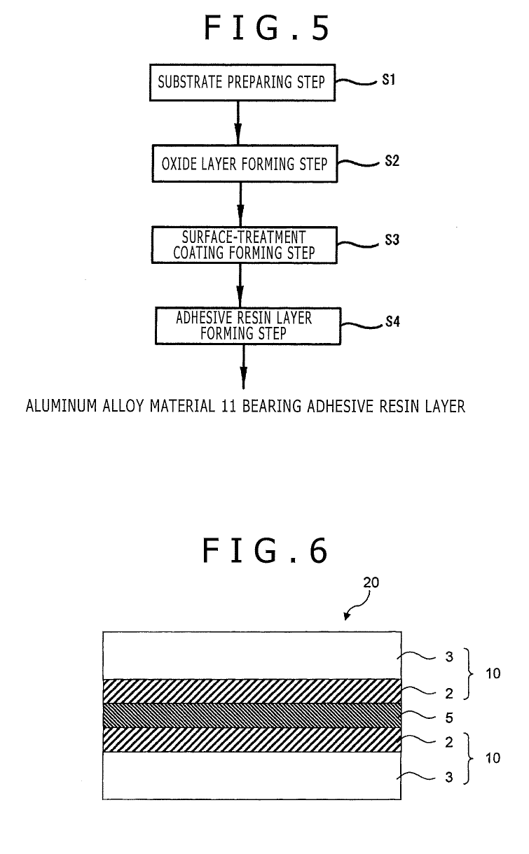

Next, a method for producing the aluminum alloy material 11 bearing an adhesive resin layer according to the modification will be described. FIG. 5 is a flow chart illustrating the method for producing the aluminum alloy material 11 bearing an adhesive resin layer according to the modification. As illustrated in FIG. 5, the method for producing the aluminum alloy material 11 bearing an adhesive resin layer according to the modification further includes an adhesive resin layer forming step S4, in addition to the steps S1 to S3.

Step S4: Adhesive Resin Layer Forming Step

The adhesive resin layer forming step S4 forms the adhesive resin layer 4 typically from an adhesive, so as to cover the surface treatment layer 2. The technique to form the adhesive resin layer 4 is not limited. For example, when the adhesive resin is solid, the adhesive resin layer 4 may be formed by compression bonding with heating or by dissolving the adhesive resin in a solvent to give a solution, and spraying or applying the solution onto the surface treatment layer 2. When the adhesive layer is liquid, the adhesive resin layer 4 may be formed by spraying or applying the adhesive resin as intact onto the surface treatment layer 2.

The method for producing the aluminum alloy material 11 bearing an adhesive resin layer according to the modification may further include a pre-aging step of performing pre-aging, after the oxide layer forming step S2, the surface treatment layer forming step S3, and/or the adhesive resin layer forming step S4, as in the first embodiment.

The aluminum alloy material bearing an adhesive resin layer according to the modification, as including the adhesive resin layer beforehand, can omit an operation such as application of an adhesive resin onto the aluminum alloy material upon production of the bonded article or the automobile member.

Other configurations and advantageous effects of the aluminum alloy material bearing an adhesive resin layer according to the modification than those mentioned above are as in the first embodiment.

### Second Embodiment

Next, the bonded article according to the second embodiment of the present invention will be described. The bonded article according to the embodiment employs the aluminum alloy material according to the first embodiment, or the aluminum alloy material bearing an adhesive resin layer according to the modification of the first embodiment. FIGS. 6 to 9B are schematic cross-sectional views of the bonded article according to the embodiment and illustrate exemplary configurations of the bonded article. In FIGS. 6 to 9B, a component identical to that in the aluminum alloy material 10 and the aluminum alloy material 11 bearing an adhesive resin layer illustrated in FIGS. 3 and 4 is indicated with an identical reference sign, and detailed description of which is omitted therein.

Configurations of Bonded Article

The bonded article according to the embodiment can have, for example, a configuration as in a bonded article 20 illustrated in FIG. 6, in which two plies of the aluminum alloy material 10 illustrated in FIG. 3 are disposed so that sides on which the surface treatment layer 2 is formed face each other, and the two aluminum alloy materials are bonded through an adhesive resin 5. Specifically, in the bonded article 20, the adhesive resin 5 is bonded, in one side thereof to the surface treatment layer 2 side of one of the aluminum alloy materials 10 and is bonded, in the other side, to the surface treatment layer 2 side of the other aluminum alloy material 10.

The adhesive resin 5 for use in the bonded article according to the embodiment may be selected from the adhesive resins for use to constitute the adhesive resin layer 4. Specifically, the adhesive resin 5 for use herein can be selected typically from epoxy resins, urethane resins, nitrile resins, nylon resins, and acrylic resins. The thickness of the adhesive resin 5 is not limited, but is preferably 10 to 500 μm, and more preferably 50 to 400 μm, from the viewpoint of offering higher bond strength.

The adhesive resin 5 in the bonded article 20 is in contact with, on its both sides, the surface treatment layers 2 of the aluminum alloy materials 10 according to the first embodiment, as described above. The bonded article 20, when applied to an automobile member, resists deterioration in bond strength at the interfaces between the adhesive resin 5 and the surface treatment layers 2 and thus offers better bond durability, even when exposed to a hot and humid environment. The bonded article 20 according to the embodiment contributes to better bond durability at the interfaces with anyone of adhesive resins conventionally used in bonding of aluminum alloy materials, regardless of the type of the adhesive resin 5.

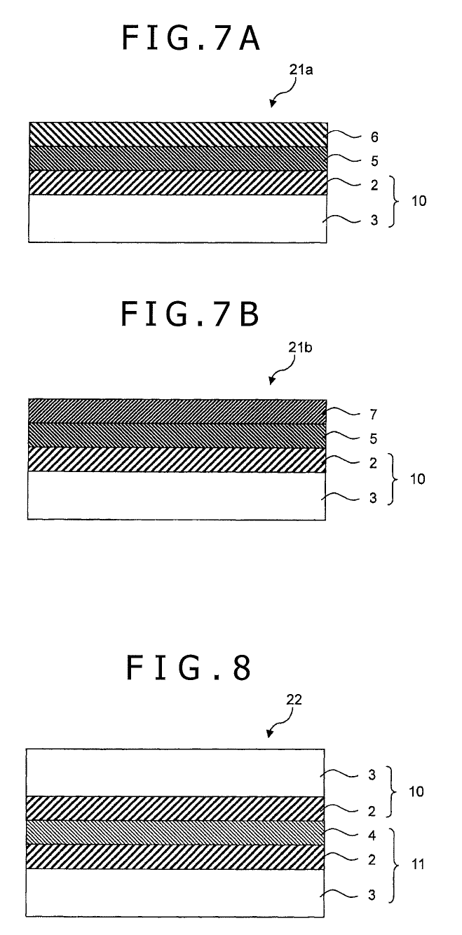

The bonded article according to the embodiment can also have a configuration as in a bonded article 21a illustrated in FIG. 7A, or a bonded article 21b illustrated in FIG. 7B. In the configuration, another aluminum alloy material 6 bearing neither oxide layer nor surface treatment layer, or a resin molded article 7 is bonded through the adhesive resin 5 to the surface treatment layer 2 side of the aluminum alloy material 10 illustrated in FIG. 3.

The other aluminum alloy material 6 bearing neither oxide layer nor surface treatment layer for use herein may be made from any of aluminum alloys as with the substrate 3. Specifically, non-limiting examples of the aluminum alloy material 6 include those made from various non-heat-treatment type or heat-treatment type aluminum alloys prescribed in, or according approximately to, JIS standards.

Non-limiting examples of the resin molded article 7 for use herein include fiber-reinforced plastic molded articles made from various fiber-reinforced plastics such as glass fiber-reinforced plastics (GFRPs), carbon fiber-reinforced plastics (CFRPs), boron fiber-reinforced plastics (BFRPs), aramid fiber-reinforced plastics (AFRPs, KFRPs), polyethylene fiber-reinforced plastics (DFRPs), and ZYLON-reinforced plastics (ZFRPs). The use of any of these fiber-reinforced plastic molded articles enables weight reduction of the bonded article while maintaining its strength at certain level.

Other than the fiber-reinforced plastics, the resin molded article 7 may also be made from non-fiber-reinforced resins such as polypropylenes (PPs), acrylonitrile-butadiene-styrene copolymer (ABS) resins, polyurethanes (PUs), polyethylenes (PEs), polyvinyl chloride)s (PVCs), nylon 6, nylon 66, polystyrenes (PSs), poly(ethylene terephthalate)s (PETS), polyamides (PAs), poly(phenylene sulfide)s (PPSs), polybutylene terephthalate)s (PBTs), and polyphthalamides (PPAs).

In the bonded articles 21a and 21b respectively illustrated in FIGS. 7A and 7B, one side of the adhesive resin 5 is bonded to the surface treatment layer 2 side. The bonded articles 21a and 21b, when used in an automobile member and even when exposed to a hot and humid environment, offers better bond durability at the interface regardless of the type of the adhesive resin, as with the bonded article 20. The bonded article 21b illustrated in FIG. 7B, in which the aluminum alloy material 10 and the resin molded article 7 are bonded to each other, has a lighter weight as compared with a bonded article between two aluminum alloy materials. The bonded article 21b, when used, enables further weight reduction of automobiles. Other configurations and advantageous effects in the bonded articles 21a and 21b illustrated in FIGS. 7A and 7B than those mentioned above are as in the bonded article 20 illustrated in FIG. 6.

The bonded article according to the embodiment can also have a configuration as with a bonded article 22 illustrated in FIG. 8. In this configuration, the aluminum alloy material 11 illustrated in FIG. 4, which includes the adhesive resin layer 4, is bonded to the aluminum alloy material 10 illustrated in FIG. 3, which does not include the adhesive resin layer 4. Specifically, this bonded article includes the aluminum alloy material 10 and the aluminum alloy material 11 bearing an adhesive resin layer, where the surface treatment layer 2 of the aluminum alloy material 10 is bonded to the adhesive resin layer 4 of the aluminum alloy material 11. As a result, in this configuration, the surface treatment layer 2 of the aluminum alloy material 10 and the surface treatment layer 2 of the aluminum alloy material 11 face each other through the adhesive resin layer 4 of the aluminum alloy material 11.

In the bonded article 22, both sides of the adhesive resin layer 4 are bonded to the two surface treatment layers 2. Therefore, the bonded article 22, when used to give an automobile member and even when exposed to a hot and humid environment, offers better bond durability at the interfaces regardless of the type of the adhesive resin, as with the bonded article 20. Other configurations and advantageous effects in the bonded article 22 illustrated in FIG. 8 than those mentioned above are as with the bonded article 20 illustrated in FIG. 6.

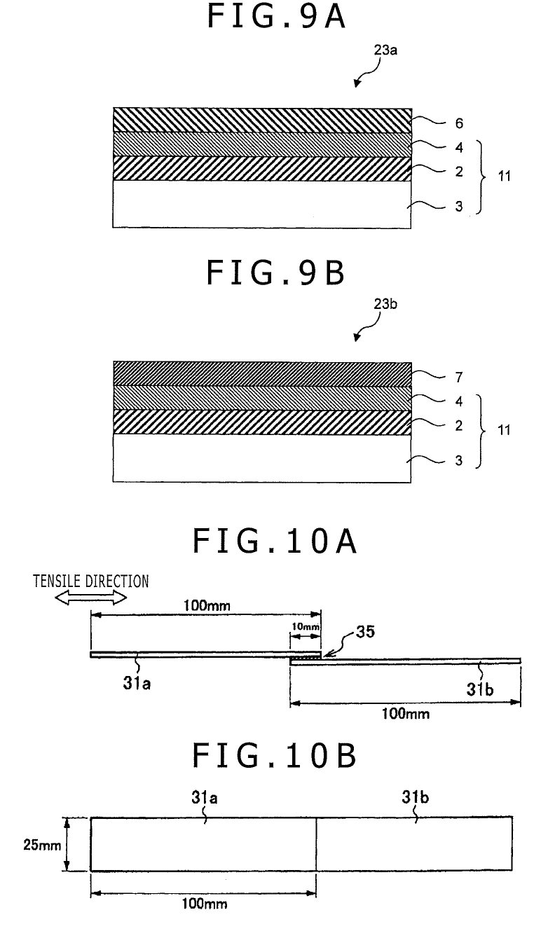

The bonded article according to the embodiment can also have a configuration as with a bonded article 23a illustrated in FIG. 9A or a bonded article 23b illustrated in FIG. 9B. In this configuration, another aluminum alloy material 6 bearing no surface treatment layer, or a resin molded article 7 is bonded to the adhesive resin layer 4 side of the aluminum alloy material 11 illustrated in FIG. 4. A non-limiting example of the resin molded article is a fiber-reinforced plastic molded article. In these bonded articles 23a and 23b, one side of the adhesive resin layer 4 is bonded to the surface treatment layer 2 side. These bonded articles 23, when used to give an automobile member and even when exposed to a hot and humid environment, offer better bond durability at the interface regardless of the type of the adhesive resin, as with the bonded article 20.

The bonded amide 23b illustrated in FIG. 9B, in which the aluminum alloy material 11 bearing an adhesive resin layer and the resin molded article 7 are bonded to each other, has a lighter weight as compared with a bonded article between two aluminum alloy materials and is advantageous as or in members of automobiles and other vehicles. Other configurations and advantageous effects in the bonded articles 23a and 23b illustrated in FIGS. 9A and 9B than those mentioned above are as with the bonded article 20 illustrated in FIG. 6.

Bonded Article Production Method

Methods, in particular bonding methods, for producing the bonded articles 20 to 23 can be selected from conventional, known bonding methods. The adhesive resin 5 may be formed on the aluminum alloy material typically, but non-limitingly, by using an adhesive sheet prepared from the adhesive resin 5 in advance, or by spraying or applying the adhesive resin 5 onto the surface treatment layer 2. The bonded articles 20 to 23 may be coated on the surface with a machine oil such as a press forming oil before processing into an automobile member, as with the aluminum alloy material 10 and the aluminum alloy material 11 bearing an adhesive resin layer.

Assume that the bonded article according to the embodiment employs an aluminum alloy material including two surface treatment layers 2 as both surface layers thereof. In this case (not shown), the bonded article can further include anyone of the above-mentioned aluminum alloy materials, or another aluminum alloy material 6 not bearing the surface-treated coating 2, or a resin molded article 7, as bonded through the adhesive resin 5 or the adhesive resin layer 4 to the surface treatment layer 2.

### Third Embodiment

Next, an automobile member according to a third embodiment of the present invention will be described. The automobile member according to the embodiment employs the bonded article according to the second embodiment and is exemplified by, but not limited to, automobile panels.

The automobile member according to the embodiment may be produced typically, but non-limitingly, by any of conventional, known production methods. For example, the bonded articles 20 to 23b illustrated in FIGS. 6 to 9B are subjected to processing such as cutting and/or press forming to give automobile members having predetermined shapes.

The automobile member according to the embodiment, as produced from any of the bonded articles according to the second embodiment, is little affected by hydration of the adhesive resin or adhesive resin layer and the oxide layer and resists elution of the aluminum alloy substrate, even when exposed to a hot and humid environment. As a result, the automobile member according to the embodiment can resist interfacial peeling and restrain deterioration in bond strength upon exposure to a hot and humid environment.

### EXAMPLES

The present invention will be described in further detail below on advantageous effects thereof, with reference to several experimental examples indicating examples according to the present invention and comparative examples. In the experimental examples, aluminum alloy materials were prepared by a method under conditions as mentioned below, and were evaluated for properties such as bond durability.

Substrate Preparing Step and Oxide Layer Forming Step

Substrates were prepared, and oxide layers were formed in the following manner.

### Examples 1 and 2

An aluminum alloy cold-rolled sheet having a thickness of 1 mm was prepared using a 6xxx-series aluminum alloy according to JIS 6016 (0.54 mass percent Mg; 1.11 mass percent Si; and 0.14 mass percent Cu) by the above-mentioned method. The cold-rolled sheet was cut to a piece having a length of 100 mm and a width of 25 mm and used as a substrate. The substrate was heated as a heat treatment up to an attained temperature of the substrate of 550° C., followed by cooling.

Next, the substrate was treated with a potassium hydroxide-containing solution having a pH adjusted to 13, at a temperature of 50° C. for a treatment time of 1 to 120 seconds, followed by rinsing.

The substrate was then subjected to nitric acid solution treatment with a nitric acid solution having a pH adjusted to 1, at a temperature of 40° C. for a treatment time of 1 to 120 seconds, followed by rinsing, to perform etching in the etching amount given in Table 1 and to form an oxide layer having a Mg content and a Cu content controlled as indicated in Table 1.

### Examples 3 to 5

An aluminum alloy cold-rolled sheet having a thickness of 1 mm was prepared by the method, using a 6xxx-series aluminum alloy according to JIS 6016 (0.54 mass percent Mg; 1.11 mass percent Si; and 0.14 mass percent Cu). The cold-rolled sheet was cut to a piece having a length of 100 mm and a width of 25 mm and used as a substrate. The substrate was heated as a heat treatment up to an attained temperature of the substrate of 550° C., followed by cooling.

Next, the substrate was treated with a potassium hydroxide solution having a pH adjusted to 13, at a temperature of 50° C. for a treatment time of 1 to 120 seconds, followed by rinsing.

The substrate was then subjected to sulfuric acid-hydrofluoric acid solution treatment using a solution containing sulfuric acid and hydrofluoric acid and having a pH adjusted to 1, at a temperature of 50° C. for a treatment time of 1 to 120 seconds, followed by rinsing, to perform etching in the etching amount given in Table 1 and to form an oxide layer having a Mg content and a Cu content controlled as indicated in Table 1.

### Examples 6 and 7

An aluminum alloy cold-rolled sheet having a thickness of 1 mm was prepared by the method, using a 6xxx-series aluminum alloy according to JIS 6016 (0.54 mass percent Mg; 1.11 mass percent Si; and 0.14 mass percent Cu). The cold-rolled sheet was cut to a piece having a length of 100 mm and a width of 25 mm and used as a substrate. The substrate was heated as a heat treatment up to an attained temperature of the substrate of 550° C., followed by cooling.

Next, the substrate was subjected to sulfuric acid solution treatment with a sulfuric acid solution having a pH adjusted to 1, at a temperature of 60° C. for a treatment time of 1 to 120 seconds, followed by rinsing, to perform etching in the etching amount given in Table 1 and to form an oxide layer having a Mg content and a Cu content controlled as indicated in Table 1.

### Examples 8 and 9

An aluminum alloy cold-rolled sheet having a thickness of 1 mm was prepared by the method, using a 6xxx-series aluminum alloy according to JIS 6016 (0.54 mass percent Mg; 1.11 mass percent Si; and 0.14 mass percent Cu). The cold-rolled sheet was cut to a piece having a length of 100 mm and a width of 25 mm and used as a substrate. The substrate was heated as a heat treatment up to an attained temperature of the substrate of 550° C., followed by cooling.

Next, the substrate was subjected to nitric acid solution treatment with a nitric acid solution having a pH adjusted to 3, at a temperature of 50° C. for a treatment time of 1 to 60 seconds, followed by rinsing, to perform etching in the etching amount given in Table 1 and to form an oxide layer having a Mg content and a Cu content controlled as indicated in Table 1.

### Comparative Example 1

The substrate was treated under conditions similar to those in Examples 3 to 5, except for performing the potassium hydroxide solution treatment for a treatment time of 150 seconds, and performing the treatment with the solution containing sulfuric acid and hydrofluoric acid for a treatment time of 150 seconds, to perform etching in the etching amount given in Table 1 and to form an oxide layer having a Mg content and a Cu content controlled as indicated in Table 1.

### Comparative Example 2

An aluminum alloy cold-rolled sheet having a thickness of 1 mm was prepared by the method, using a 6xxx-series aluminum alloy according to JIS 6016 (0.54 mass percent Mg; 1.11 mass percent Si; and 0.14 mass percent Cu). The cold-rolled sheet was cut to a piece having a length of 100 mm and a width of 25 mm and used as a substrate. The substrate was heated as a heat treatment up to an attained temperature of the substrate of 550° C., followed by cooling. In Comparative Example 2, the prepared substrate was not subjected to alkaline degreasing and acid wash.

Surface-Treatment Coating Forming Step

Next, onto the oxide layer formed on each of the aluminum alloy substrates, which were prepared in Examples 1 to 9 and Comparative Examples 1 and 2, an aqueous solution (surface treatment solution) was applied by clipping or coating with a bar water to form a surface treatment layer, and yielded aluminum alloy materials according to the examples and the comparative examples. The aqueous solution contained 0.1 mass percent of crystalline layered sodium silicate (mole ratio of SiO₂ to Na₂O: about 2; PURIFEED, supplied by Tokuyama Siltech Co., Ltd) and 0.09 mass percent of bis(triethoxysilyl)ethane (BTSE) and had a pH adjusted to 11.2. In the preparation of the aqueous solution (surface treatment solution), ethanol and acetic acid were used for dissolution of BTSE and for pH adjustment, but no fluorine-containing agent was used. The prepared solution had an ethanol content of about 2% of the totality of the solution. The surface treatment solution after application was dried at 105° C. for 1 minute. The coating (coating) after drying was found to be present in a mass of coating of about 4 mg/m², as a result of measurement by X-ray fluorescence analysis before and after coating.

### Example 10

Onto the oxide layer formed on the aluminum alloy substrate, which was prepared in Example 1, an aqueous solution (surface treatment solution) was applied using a bar water to form a surface treatment layer, and yielded an aluminum alloy material according to Example 10. The aqueous solution contained 0.1 mass percent of sodium meta-silicate (mole ratio of SiO₂ to Na₂O: about 1) and 0.09 mass percent of bis(triethoxysilyl)ethane (BTSE) and had a pH adjusted to 11.2. In the preparation of the aqueous solution (surface treatment solution), ethanol and acetic acid were used for dissolution of BTSE and for pH adjustment, but no fluorine-containing agent was used. The prepared solution had an ethanol content of about 2% of the totality of the solution. The surface treatment solution after application was dried at 105° C. for 1 minute. The coating (coating) after drying was found to be present in a mass of coating of 3.8 mg/m², as a result of measurement by X-ray fluorescence analysis before and after coating.

### Example 11

Onto the oxide layer formed on the aluminum alloy substrate surface, which was obtained in Example 1, an aqueous solution (surface treatment solution) was applied using a bar coater to form a surface treatment layer, and yielded an aluminum alloy material according to Example 11. The aqueous solution contained 0.1 mass percent of water glass (mole ratio of SiO₂ to Na₂O: about 3 to 3.4) and 0.09 mass percent of bis(triethoxysilyl)ethane (BTSE) and had a pH adjusted to 11.2. In the preparation of the aqueous solution (surface treatment solution), ethanol and acetic acid were used for dissolution of BTSE and for pH adjustment, but no fluorine-containing agent was used. The prepared solution had an ethanol content of about 2% of the totality of the solution. The surface treatment solution after application was dried at 105° C. for 1 minute. The coating (coating) after drying was found to be present in a mass of coating of 4.2 mg/m², as a result of measurement by X-ray fluorescence analysis before and after coating.

### Comparative Example 3

Onto the oxide layer formed on the aluminum alloy substrate surface, which was obtained in Example 1, an aqueous solution (surface treatment solution) was applied using a bar coater to form a surface treatment layer, and yielded an aluminum alloy material according to Comparative Example 3. The aqueous solution contained 0.55 mass percent of crystalline layered sodium silicate (mole ratio of SiO₂ to Na₂O: about 2; PURIFEED, supplied by Tokuyama Siltech Co., Ltd.) and 0.05 mass percent of bis(triethoxysilyl)ethane (BTSE) and had a pH adjusted to 12.1. In the preparation of the aqueous solution (surface treatment solution), ethanol and acetic acid were used for dissolution of BTSE and for pH adjustment, but no fluorine-containing agent was used. The prepared solution had an ethanol content of about 2% of the totality of the solution. The surface treatment solution after application was dried at 105° C. for 1 minute. The coating (coating) after drying was found to be present in a mass of coating of about 35 mg/m², as a result of measurement by X-ray fluorescence analysis before and after coating.

### Comparative Example 4

Onto the oxide layer formed on the aluminum alloy substrate surface, which was obtained in Example 1, an aqueous solution (surface treatment solution) was applied using a bar coater to form a surface treatment layer, and thereby yielded an aluminum alloy material according to Comparative Example 4. The aqueous solution contained 0.061 mass percent of crystalline layered sodium silicate (mole ratio of SiO₂ to Na₂O: about 2; PUBWEED, supplied by Tokuyama Siltech Co., Ltd.) and 0.8 mass percent of bis(triethoxysilyl)ethane (BTSE) and had a pH adjusted to 11.0. In the preparation of the aqueous solution (surface treatment solution), ethanol and acetic acid were used for dissolution of BTSE and for pH adjustment, but no fluorine-containing agent was used. The prepared solution had an ethanol content of about 2% of the totality of the solution. The surface treatment solution after application was dried at 105° C. for 1 minute. The coating (coating) after drying was found to be present in a mass of coating of about 36 mg/m², as a result of measurement by X-ray fluorescence analysis before and after coating.

Each of the aluminum alloy materials prepared in the above manner according to the examples and the comparative examples was coated on its second coating with a press forming oil diluted with toluene, so that the oil after drying be present in a mass of coating of 1 g/m².

Measurement of Oxide Layer Chemical Composition

Each of the oxide layers on the aluminum alloy substrates according to the examples and the comparative examples after formation of the oxide layer and before formation of the surface treatment layer was subjected to measurement of contents of elements by glow discharge-optical emission spectroscopy (GD-OES, using Model JY-5000RF supplied by HORIBA Jobin Yvon SAS) while performing sputtering in the thickness direction. Examples of the elements to be measured herein include metal elements such as aluminum (Al), magnesium (Mg), copper (Cu), iron (Fe), and titanium (Ti); and other elements such as oxygen (O), nitrogen (N), carbon (C), silicon (Si), and sulfur (S). For magnesium (Mg), copper (Cu), and silicon (Si), highest contents (concentrations) of magnesium (Mg), copper (Cu), and silicon (Si) in the oxide layer were defined as the contents of the elements in the oxide layer. In the calculation of the contents of these elements, in particular, oxygen (O) and carbon (C) tend to be affected by contamination in portions in, or adjacent to, the outermost surface. Accordingly, the contents of the elements were calculated, while excluding oxygen (O) and carbon (C). In particular, oxygen (O) may be highly possibly affected by contamination in portions in, or adjacent to, the outermost surface, and this impedes measurement of accurate concentration. However, it was apparent that the oxide layers of all the samples contained oxygen (O).

Etching Amount

The etching amount (in g/cm²) was calculated by measuring the weight loss (in gram) of the substrate after the oxide layer forming step as compared with the weight before the step, and dividing the weight loss by the surface area (in square meter) of the substrate.

Cohesive Failure Rate (Bond Durability) FIGS. 10A and 10B are a side view and a plan view, respectively, of a bonded test sample and schematically illustrate how to measure a cohesive failure rate. As illustrated in FIGS. 10A and 10B, two test samples 31a and 31b (25 mm wide) having the same configuration were partially overlaid on each other at edges with an overlapping length of 10 mm (adhesive area: 25 mm by 10 mm) and bonded to each other using a thermosetting epoxy resin-containing adhesive resin.

The adhesive resin 35 used herein was a thermosetting epoxy resin-containing adhesive resin (containing a bisphenol-A epoxy resin in a content of 40 to 50 mass percent). The adhesive resin 35 was combined with a trace amount of glass beads (having a particle size of 250 μm) so as to adjust the thickness of the layer of the adhesive resin 35 to 250 μm.

The resulting article was dried at room temperature for 30 minutes after the overlapping, and then heated at 170° C. for 20 minutes to perform thermosetting. The article was then left stand at mom temperature for 24 hours and yielded a bonded test sample.

The prepared bonded test sample was held in a hot and humid environment at a temperature of 50° C. and relative humidity of 95% for 30 days, then pulled using a tensile tester at a speed of 50 mm/min., and the cohesive failure rate of the adhesive resin in the bonded portion was evaluated. The cohesive failure rate was calculated according to following Mathematical Expression 1. In Mathematical Expression 1, one of the two test specimens constituting the bonded test sample after pulling was defined as a test specimen “a”, and the other was defined as a test specimen “b”.

Cohesive failure rate(%)=100−[(Interfacial peeling area of test specimen“a”)/(Bonded area of test specimen“a”)×100+(Interfacial peeling area of test specimen“b”)/(Bonded area of test specimen“b”)×100] [Math. 1]

Three bonded test samples were prepared per each test condition, and the average of three measurements was defined as the cohesive failure rate. According to evaluation criteria, a sample having a cohesive failure rate of less than 60% was evaluated as having poor bond durability (x); a sample having a cohesive failure rate of 60% to less than 70% was evaluated as having somewhat good bond durability (Δ); a sample having a cohesive failure rate of 70% to less than 90% was evaluated as having good bond durability (◯); and a sample having a cohesive failure rate of 90% or more was evaluated as having very good bond durability (⊚). Samples having a cohesive failure rate of 60% or more were evaluated as accepted.

Results of the above evaluations and measurements are collectively presented in Table 1.

TABLE 1

| | | Oxide coating forming step | | | | | |
|---|---|---|---|---|---|---|---|
| | | | | | | GL-OES peak | |
| | | Alkali | Acid | | Etching amount | concentration | |
| | No. | wash | wash | Detailed treatment | (g/m²) | Mg (at %) | Cu (at %) |
| Examples | 1 | ◯ | ◯ | alkali degreasing →nitric acid | 0.18 | 2.52 | 0.19 |
| | 2 | ◯ | ◯ | alkali degreasing →nitric acid | 0.61 | 1.56 | 0.35 |
| | 3 | ◯ | ◯ | alkali degreasing →sulfuric acid | 1.11 | 0.59 | 0.41 |
| | | | | and hydrofluoric acid | | | |
| | 4 | ◯ | ◯ | alkali degreasing →sulfuric acid | 0.85 | 0.79 | 0.39 |
| | | | | and hydrofluoric acid | | | |
| | 5 | ◯ | ◯ | alkali degreasing →sulfuric acid | 1.61 | 0.39 | 0.59 |
| | | | | and hydrofluoric acid | | | |
| | 6 | — | ◯ | sulfuric acid | 0.24 | 0.23 | 0.28 |
| | 7 | — | ◯ | sulfuric acid | 0.029 | 9.80 | 0.14 |
| | 8 | — | ◯ | nitric acid | 0.015 | 19 | 0.06 |
| | 9 | — | ◯ | nitric acid | 0.005 | 28 | 0.04 |
| | 10 | ◯ | ◯ | alkali degreasing →nitric acid | 0.18 | 2.52 | 0.19 |
| | 11 | ◯ | ◯ | alkali degreasing →nitric acid | 0.18 | 2.52 | 0.19 |
| Comparative | 1 | ◯ | ◯ | alkali degreasing →sulfuric acid | 1.99 | 0.46 | 0.67 |
| Examples | | | | and hydrofluoric acid | | | |
| | 2 | — | — | not washed | 0.000 | 35 | 0.05 |
| | 3 | ◯ | ◯ | alkali degreasing →nitric acid | 0.18 | 2.52 | 0.19 |
| | 4 | ◯ | ◯ | alkali degreasing →nitric acid | 0.18 | 2.52 | 0.19 |

| | | | Surface-treatment layer forming step | | | | |
|---|---|---|---|---|---|---|---|
| | | | | Silicate | BTSE | | Evaluation |
| | | Coating | Silicate | concentration | concentration | | Cohesive |
| | No. | method | type | (mass %) | (mass %) | pH | failure rate |
| Examples | 1 | bar coating | A | 0.1 | 0.09 | 11.2 | ⊚ |
| | 2 | dipping | A | 0.1 | 0.09 | 11.2 | ⊚ |
| | 3 | bar coating | A | 0.1 | 0.09 | 11.2 | ⊚ |
| | 4 | dipping | A | 0.1 | 0.09 | 11.2 | ⊚ |
| | 5 | bar coating | A | 0.1 | 0.09 | 11.2 | ◯ |
| | 6 | dipping | A | 0.1 | 0.09 | 11.2 | ⊚ |
| | 7 | dipping | A | 0.1 | 0.09 | 11.2 | ⊚ |
| | 8 | dipping | A | 0.1 | 0.09 | 11.2 | ◯ |
| | 9 | dipping | A | 0.1 | 0.09 | 11.2 | Δ |
| | 10 | bar coating | B | 0.1 | 0.09 | 11.2 | ◯ |
| | 11 | bar coating | C | 0.1 | 0.09 | 11.2 | ⊚ |
| Comparative | 1 | dipping | A | 0.1 | 0.09 | 11.2 | X |
| Examples | | | | | | | |
| | 2 | dipping | A | 0.1 | 0.09 | 11.2 | X |
| | 3 | bar coating | A | 0.55 | 0.05 | 12.1 | X |
| | 4 | bar coating | A | 0.061 | 0.8 | 11.0 | X |

A: Crystalline layered sodium silicate (mole ratio of SiO₂ to Na₂O: about 2; PURIFEED, supplied by Tokuyama Siltech Co., Ltd.)
B: Sodium metasilicate (mole ratio of SiO₂ to Na₂O: about 1)
C: Water glass (mole ratio of SiO₂ to Na₂O: 3 to 3.4)

As indicated in Table 1, the aluminum alloy material according to Comparative Example 1, having a Cu content in the oxide layer out of the range specified in the present invention, had a low cohesive failure rate of less than 60% and offered poor bond durability in a hot and humid environment.

The aluminum alloy material according to Comparative Example 2, prepared without acid wash and alkali wash, had a Mg content in the oxide layer out of the range specified in the present invention, had a low cohesive failure rate of less than 60%, and offered poor bond durability in a hot and humid environment.

The aluminum alloy material according to Comparative Example 3, having a silicate concentration in the surface treatment solution out of the range specified in the present invention, had a low cohesive failure rate of less than 60% and offered poor bond durability in a hot and humid environment.

The aluminum alloy material according to Comparative Example 4, having an organic silane compound concentration in the surface treatment solution out of the range specified in the present invention, had a low cohesive failure rate of less than 60% and offered poor bond durability in a hot and humid environment.

In contrast, the aluminum alloy materials according to Examples 1 to 11, which were produced by the production method according to the present invention, each had a cohesive failure rate of 60% or more and offered good bond durability even in a hot and humid environment.

The sample according to Example 10 is a sample prepared under conditions approximately the same as those in Example 1, except for using sodium silicates of different types. Specifically, sodium metasilicate (mole ratio of SiO₂ to Na₂O: about 1) was used in this sample instead of the crystalline layered sodium silicate (mole ratio of SiO₂ to Na₂O; about 2; PURIFEED, supplied by Tokuyama Siltech Co., Ltd.) used in Example 1. The sample according to Example 10, using sodium metasilicate having a mole ratio of SiO₂ to Na₂O of less than 1.5 (about 1), had a cohesive failure rate of 70% to less than 90% at an acceptable level, but had a somewhat lower cohesive failure rate as compared with the sample according to Example 1, using the crystalline layered sodium silicate having a mole ratio of SiO₂ to Na₂O of about 2.

The sample according to Example 11 is a sample prepared under conditions approximately the same as those in Example 1, except for using a sodium silicate of different type. Specifically, water glass (mole ratio of SiO₂ to Na₂O: about 3 to 3.4) was used instead of the crystalline layered sodium silicate (mole ratio of SiO₂ to Na₂O about 2; PURIFEED, supplied by Tokuyama Siltech Co., Ltd.) used in Example 1. The sample according to Example 11, using water glass having a mole ratio of SiO₂ to Na₂O of 1.5 or more (about 3 to about 3.4), had a cohesive failure rate equivalent to that of the sample according to Example 1, using the crystalline layered sodium silicate having a mole ratio of SiO₂ to Na₂O of about 2.

While the present invention has been particularly described in detail with reference to specific embodiments thereof it is obvious to those skilled in the art that various changes and modifications may be made without departing from the spirit and scope of the present invention.

This application is based on, and claims priority to, Japanese Patent Application No. 2015-138049, filed on Jul. 9, 2015; Japanese Patent Application No. 2016-094922, filed on May 10, 2016; and Japanese Patent Application No. 2016-113753, filed on Jun. 7, 2016, the entire contents of each of which applications are incorporated herein by reference.

### REFERENCE SIGNS LIST

1 oxide layer
2 surface treatment layer
3 substrate
4 adhesive resin layer
5, 35 adhesive resin
6, 10 aluminum alloy material
11 aluminum alloy material bearing an adhesive resin layer
7 resin molded article
20, 21a, 21b, 22, 23a, 23b bonded article
31a, 31b test sample

1. A method for producing an aluminum alloy material, the method comprising:
first forming an oxide layer on at least part of an aluminum alloy substrate,
the oxide layer comprising Mg in a content from 0.1 atomic percent to less than 30 atomic percent and having a Cu content contorted to less than 0.6 atomic percent; and
second forming a surface treatment layer,
the second forming comprising:
applying an aqueous solution to at least part of the oxide layer,
the aqueous solution having a pH of 7 to 14 and comprising:
a silicate in a concentration of 0.001 mass percent to less than 0.5 mass percent; and
an organic silane compound in a concentration of 0.001 mass percent to less than 0.5 mass percent.

2. The method according to claim 1,
wherein the organic silane compound comprises at least one of:
a silane compound containing a plurality of hydrolyzable trialkoxysilyl groups in a molecule;
a hydrolyzed product of the silane compound; and
a polymer derived from the silane compound.

3. The method according to claim 1,
wherein the silicate is a silicate represented by mM₂O.nSiO₂,
where M is a monovalent cation; m is a number of moles of M₂O; and n is a number of moles of SiO₂, and
wherein a ratio (n/m) of n to m is 1.5 or more.

4. The method according to claim 3,
wherein M is a sodium ion.

5. The method according to claim 1,
wherein the first forming comprises etching, and
wherein the etching is performed to an amount of 1.9 g/m² or less.

6. The method according to claim 1,
wherein the aluminum alloy substrate comprises an aluminum alloy selected from the group consisting of:
an Al—Mg alloy;
an Al—Cu—Mg alloy;
an Al—Mg—Si alloy; and
an Al—Zn—Mg alloy.

7. An aluminum alloy material obtained by the method according to claim 1.

8. A bonded article comprising:
the aluminum alloy material according to claim 7;
another member; and
an adhesive resin through which the aluminum alloy material and the other member bond with each other.
